(19) United States
(12) Patent Application Publication
(10) Pub. No.: US 2016/0177156 A1
(43) Pub. Date: Jun. 23, 2016

(54) THERMALLY CONDUCTING CAPSULES COMPRISING A PHASE CHANGE MATERIAL

(71) Applicant: COMMISSARIAT A L'ENERGIE ATOMIQUE ET AUX ENERGIES ALTERNATIVES, Paris (FR)

(72) Inventors: Jonathan SKRZYPSKI, Gurgy (FR); Olivier PONCELET, Grenoble (FR); Chloé SCHUBERT, Tignes (FR)

(21) Appl. No.: 14/893,265

(22) PCT Filed: May 19, 2014
(86) PCT No.: PCT/IB2014/061539

§ 371 Date: Nov. 23, 2015

(30) Foreign Application Priority Data
May 21, 2013 (FR) 13 54549

(51) Int. Cl. C09K 5/06; B01J 13/14

(52) U.S. Cl. CPC C09K 5/063; B01J 13/14

(57) ABSTRACT

The invention relates to a thermally conducting capsule which has a core-shell structure and in which the core, which is surrounded by a tight single-layer or multilayer shell, is loaded with at least one phase change material (PCM). The invention is characterized in that the capsule also contains particles made of an additional conducting material at least in the shell, said particles made of the additional conducting material having a thermal conductivity greater than 100 W/m/K. The invention further relates to the use of said capsule in a heat-conducting material, in particular a thermal fluid, in order to modulate the heat capacity thereof.

The present invention is targeted at providing mainly thermally conducting capsules comprising a phase change material (PCM). Such capsules are of use in particular for increasing the thermal conductivity and the heat capacity of heat-exchanging materials or also of thermal fluids and more particularly of the polyaromatic oils used in concentrated solar thermal power.

“Phase change material” within the meaning of the invention is understood to mean a material capable of absorbing or releasing a large amount of energy in the form of latent heat during a liquid/solid phase transition, over a narrow temperature range.

The PCMs may be of organic nature as well as of inorganic nature. As regards the organic PCMs, they are mainly paraffins or sugars. With regard to the inorganic PCMs, they are generally salts, metals or alloys.

Generally, the PCMs are employed in applications where it is desired to benefit from their property of storing energy due to their latent heat of fusion. PCMs having a low melting point may in particular be used to improve the thermal insulation of buildings, while PCMs having a high melting point find application in the field of high-temperature solar thermal power.

As regards the field of high-temperature solar thermal power, use is generally made therein, as thermal fluid, of aromatic or also polyaromatic oils. However, the maximum temperature of use of these oils is of the order of 350° C. This is because, beyond this temperature, a polyaromatic oil is generally degraded and it is then necessary to replace it. In point of fact, this type of oil is expensive. A known means for overcoming this degradation is to improve the conducting properties of it by adding precisely one PCM thereto.

In the more specific field of high-temperature solar thermal power, the PCMs most often considered are organic salts and metals, and also alloys. The latter may in particular be provided in the form of storage silos, for example for molten salts, which make it possible to keep the power stations operating during the night and days of low light levels.

However, when PCM particles are introduced as such, that is to say in a form directly dispersed in a heat transfer material, the heat capacity of which it is desired to adjust, a phenomenon of agglomeration of these particles may occur during the different cycles. This agglomeration phenomenon arises very particularly in an aromatic oil, which is a nonpolar fluid and thus not favorable to the stabilization of a dispersion of particles via electrostatic interactions. For obvious reasons, this phenomenon is harmful insofar as it brings about a loss of a portion of the heat stored.

In order to overcome this failing, microcapsules comprising PCMs and with a shell having an improved resistance, in particular to temperature, have already been developed. Mention may in particular be made, by way of representation of these microparticles, of the melamine/formaldehyde systems capable of displaying a prolonged stability over time and at high temperatures [1, 2, 3].

Unfortunately, this alternative is not completely satisfactory. There is in particular observed a loss of a portion of the energy stored by the PCM in the shell forming the capsule.

Consequently, there remains a need to develop capsules having a low manufacturing cost, the shell of which displays a good thermal conductivity, in order to ensure the transfer of the heat flow to the core, while retaining leaktightness. This is because, in the event of the encapsulated PCM having an oxidizing power with regard to a heat-exchanging material, such as, for example, an oil, it is imperative to prevent any potential escape of this PCM.

There also remains a need to have available capsules, the shell of which has a sufficient resistance to the mechanical stresses due to the thermal expansion of the PCM and which, furthermore, constitutes only a relatively low proportion by weight with respect to the weight of the capsule.

Finally, in the specific case of concentrated solar thermal power, which uses mainly polyaromatic oils as heat-conducting fluids, it would be particularly advantageous for the capsule to be compatible with the encapsulation of a PCM simultaneously exhibiting a high latent heat of fusion, a thermal conductivity greater than or equal to that of the oil and a density as close as possible to that of the oil, in order to guarantee stability of the oil/capsules mixture.

The present invention is targeted specifically at meeting these needs.

Thus, according to one of its aspects, a subject matter of the present invention is a thermally conducting capsule having a core/shell structure, the core of which, surrounded by a leaktight and mono- or multilayer shell, is charged with at least one phase change material (PCM), characterized in that said capsule additionally comprises, at least in its shell, particles of at least one ancillary conducting material, said particles of said ancillary conducting material having a thermal conductivity of greater than 100 W/m/K.

The inventors have thus found that the incorporation of a conducting material in the shell delimiting the cavity containing the PCM makes it possible, contrary to all expectations, to improve the heat transfer between the PCM and the medium containing the capsules, this being achieved without detrimentally affecting the resistance of the shell to the mechanical stresses due to the thermal expansion of the PCM. These two aspects are respectively illustrated in examples 5 and 7 below.

Obviously, the particles of the ancillary conducting material are capable of establishing thermal bridges between said PCM and the medium dedicated to containing said capsule.

According to a specific embodiment of the invention, said capsule has a bilayer shell. More particularly, in this embodiment of a capsule having a bilayer shell, the layer in contact with the core of said capsule comprises at least silica and the external layer of said capsule comprises at least one thermosetting polymer.

The present invention is also targeted at a process for the preparation of such a capsule having a bilayer shell which comprises at least the stages consisting in:
(i) bringing at least one PCM solution into contact with at least one silica precursor, in particular an alkoxysilane, preferably chosen from (3-aminopropyl)triethoxysilane (APTES), trimethoxyphenylsilane (TMPS), tetraethyl orthosilicate (TEOS), tetramethyl orthosilicate (TMOS) and their mixtures, and an aqueous medium,
(ii) exposing the mixture obtained in stage (i) to conditions favorable to the polymerization of the silica precursor in order to encapsulate said PCM,
(iii) bringing the capsule obtained in stage (ii) into contact with at least one thermosetting polymer precursor in the presence of particles of at least one ancillary conducting material, and
(iv) exposing the mixture obtained in stage (iii) to conditions favorable to the polymerization of the thermosetting polymer precursor(s).

According to another of its aspects, a subject matter of the present invention is the use of capsules according to the invention in a heat transfer material for adjusting the heat capacity thereof.

The present invention is also targeted at a thermal fluid comprising capsules according to the invention.

Another subject matter of the invention is a thermally conducting inorganic particle encapsulating exfoliated hexagonal boron nitride nanosheets.

The present invention is also targeted at the use of such particles for the manufacture of a capsule according to the invention.

According to yet another of its aspects, a subject matter of the present invention is a particle based on at least one organic or inorganic material and containing at least one aromatic PCM with a melting point ranging from 120 to 300° C., in particular from 150 to 270° C., and with a latent heat of fusion of greater than 100 J/g.

The present invention is also targeted at the use of such particles for the manufacture of a capsule according to the invention.

Another subject matter of the present invention is the use of such particles in a heat transfer material for adjusting the heat capacity thereof.

Capsule

Within the meaning of the invention, the term “capsule” is intended to define a core/shell architecture. The mono- or multilayer shell, formed of at least one organic or inorganic material, isolates the PCM(s) present in the core from the outside.

According to one of the aspects of the present invention, said capsule additionally comprises, at least in its shell, particles of at least one ancillary conducting material which advantageously prove to be capable of forming thermal bridges between said PCM and the medium dedicated to containing said capsule.

For reasons of clarity, the term “capsule” will be used, in the text which follows, to refer to an entity having core/shell architecture which contains a PCM in its core and which comprises, in its shell, said particles of an ancillary conducting material. The entities not exhibiting the combination of these characteristics will be denoted under the name of particles.

A capsule according to the invention may be just as easily on the micrometric scale as on the nanometric scale and is preferably on the nanometric scale. In particular, it may exhibit a size ranging from 30 nm to 1 μm and preferably from 50 to 300 nm.

As specified above, the capsules according to the invention have a sufficient resistance to the mechanical stresses due to the thermal expansion of the PCM during the heating/cooling cycles.

Advantageously, they are in addition resistant to a temperature of greater than 300° C., preferably of greater than 315° C. and less than 350° C.

The resistance may in particular be evaluated using several melting/crystallization cycles by differential scanning calorimetry (DSC), as described in detail in the examples.

a) Core

As specified above, a capsule according to the invention comprises, in its core, at least one phase change material, also referred to as PCM.

According to a specific embodiment of the invention, the PCM exhibits a melting point ranging from 120 to 300° C., in particular from 150 to 270° C.

Advantageously, a PCM suitable for the invention may exhibit a latent heat of fusion at least equal to 100 J/g, preferably ranging from 100 to 200 J/g, in particular ranging from 130 to 170 J/g.

Likewise, a PCM according to the invention advantageously has a thermal conductivity ranging from 0.2 to 80 W/m/K, preferably from 0.4 to 20 W/m/K, in particular from 0.6 to 10 W/m/K.

Generally, the choice of the PCM is also adjusted with regard to the nature of the heat transfer material considered.

According to a specific embodiment of the invention, this PCM is organic in nature; preferably, this PCM is an aromatic compound.

This is because, as mentioned above, a suitable PCM proves to simultaneously have a high latent heat of fusion, a thermal conductivity greater than or equal to that of the oil and a density close to that of an aromatic oil.

Mention may in particular be made, by way of illustration of the aromatic PCMs which are suitable for the invention, of pyromellitic dianhydride, naphthalenetetracarboxylic dianhydride, perylenetetracarboxylic dianhydride, anthracene and their mixtures, and in particular anthracene.

Anthracene is perfectly suitable for the present invention since it has a melting point of 220° C. and a latent heat of fusion of 160 J/g.

According to a specific embodiment of the invention, said capsule comprises a content by weight of PCM ranging from 10 to 85%, preferably from 50 to 80%, in particular from 70 to 80%, with respect to the total weight of said capsule.

Advantageously, the PCM present in the core of a capsule according to the invention is not itself organized in the form of capsules of reduced size, optionally agglomerated with one another, for example using a binder. When it is in the solid state, it is preferably provided in the form of PCM particles devoid of a core/shell architecture.

This PCM is protected from any contact with the outside via a leaktight mono- or multilayer shell.

b) Shell

Advantageously, the shell of a capsule according to the invention exhibits a thickness of less than or equal to 50 nm, preferably of less than or equal to 10 nm; in particular, said shell exhibits a thickness ranging from 5 to 10 nm.

This shell is formed of a single or nonsingle layer and advantageously comprises at least one organic material, in particular a thermosetting polymer.

This thermosetting polymer may in particular be chosen from a polyolefin, in particular polypropylene, a polyamide, a polyurea, a urea-formaldehyde, melamine-urea-formaldehyde, an aminoplast, a phenoplast and their mixtures, and is in particular a melamine-urea-formaldehyde copolymer.

According to a specific embodiment, the shell comprises at least one inorganic material, preferably silica.

According to a first alternative form of the invention, the capsule has a monolayer shell.

Examples of suitable capsules according to this alternative form may have a shell comprising silica or a thermosetting polymer, in particular a melamine-urea-formaldehyde copolymer.

According to another alternative form, the capsule has a bilayer shell.

According to this alternative form, the layer in contact with the core of said capsule may advantageously comprise at least silica and the external layer of said capsule may comprise at least one thermosetting polymer.

As specified above, a capsule according to the invention comprises, at least in its shell, particles of at least one ancillary conducting material.

Within the meaning of the invention, the term “ancillary” of the expression “ancillary conducting material” is intended to emphasize the fact that this material is distinct from the constituent material(s) of the shell of the capsule which are in particular defined above.

These particles of said ancillary conducting material advantageously have a thermal conductivity of greater than 100 W/m/K.

The thermal conductivity may in particular be measured as indicated in the paper by Duclaux et al., Physical Review B, 46(6), 1992, 3362-3367.

According to a specific embodiment, the thermal conductivity of said ancillary conducting material is at least 10 times, preferably 100 times, in particular 1000 times, greater than the thermal conductivity of said PCM.

Said particles of ancillary conducting material may have a thermal conductivity ranging from 100 to 300 W/m/K, preferably from 150 to 250 W/m/K, in particular from 175 to 225 W/m/K.

The inventors have thus found that the incorporation of a conducting material may, contrary to all expectations, be carried out in the shell of the capsules under consideration according to the invention and that the presence of the particles of such a material makes it possible to significantly improve the thermal conductivity between the PCM present in the core of the capsule and the thermal fluid conveying this capsule. The particles of the conducting material, dispersed within the shell, represent thermal bridges between the PCM and the thermal fluid.

“Thermal bridges” within the meaning of the invention is understood to mean that the particles of said ancillary conducting material are sufficiently close to one another, indeed even in contact, to be able to facilitate the transfers of heat between the PCM and the medium dedicated to containing said capsule. In other words, said particles of said ancillary conducting material, due to their proximity, indeed even their contact, create thermal bridges which make it possible to increase the thermal conductivity of the medium dedicated to containing said capsule.

To this end, at least a portion of the particles of the ancillary conducting material which are present in the shell may be close to, indeed even in contact with, the PCM.

In the same way, at least a portion of the particles of the ancillary conducting material which are present in the shell may be close to, indeed even in contact with, the external face of said capsule.

Finally, at least a portion of the particles of the ancillary conducting material may be close to, indeed even in contact with, other particles of this conducting material.

It should be noted that these thermal bridges within the meaning of the invention do not detrimentally affect the leaktightness of said capsule.

The particles of conducting material(s) according to the invention may, for example, exhibit a size ranging from 0.05 μm to 0.8 μm, preferably from 0.10 μm to 0.5 μm, in particular from 0.15 μm to 0.3 μm.

They may be of varied spherical, elongated or planar shapes. However, they are advantageously provided at least in part in the form of sheets.

This ancillary conducting material may in particular be chosen from graphene, graphite, boron nitride, in particular hexagonal boron nitride, and their mixtures.

Preferably, said ancillary conducting material is composed of boron nitride particles.

Advantageously, it is represented by at least exfoliated hexagonal boron nitride nanosheets.

A capsule according to the invention may comprise said particles of ancillary conducting material in a ratio by weight of particles of ancillary conducting material to monolayer or bilayer shell ranging from 0.5 to 10%, preferably from 0.5 to 5%, in particular of the order of 1%.

According to an alternative embodiment, a capsule according to the invention has a core charged with at least one aromatic PCM with a melting point ranging from 120 to 300° C., preferably from 150 to 270° C., and additionally contains, at least in its shell, hexagonal boron nitride nanosheets.

More particularly, a capsule according to the invention may have a core charged with at least one aromatic PCM with a melting point ranging from 120 to 300° C., preferably from 150 to 270° C., which is in particular anthracene, have a monolayer shell comprising at least silica and additionally contain, at least in its shell, hexagonal boron nitride nanosheets.

Likewise, a capsule according to the invention may advantageously have a core charged with at least one aromatic PCM with a melting point ranging from 120 to 300° C., preferably from 150 to 270° C., in particular anthracene, have a monolayer shell comprising at least one thermosetting polymer, in particular a melamine-urea-formaldehyde copolymer, and additionally contain, at least in its shell, hexagonal boron nitride nanosheets.

A capsule according to the invention may also advantageously have a core charged with at least one aromatic PCM with a melting point ranging from 120 to 300° C., preferably from 150 to 270° C., in particular anthracene, and a bilayer shell, the layer of which in contact with the core of the capsule comprises at least silica and the external layer of said capsule comprises at least melamine-urea-formaldehyde, with said capsule additionally comprising, at least in its external layer, hexagonal boron nitride nanosheets.

Process for the Preparation of a Capsule According to the Invention

As specified above, a capsule according to the invention may have a monolayer or bilayer shell.

A capsule having a monolayer shell in accordance with the invention may be obtained by any conventional microemulsion technique.

Mention may in particular be made, by way of illustration of the microemulsion techniques capable of being considered according to the invention, of those described in [7, 8, 9].

A capsule having a bilayer shell according to the invention may for its part be obtained according to the protocol described in detail below.

As specified above, this process comprises at least the stages consisting in:
(i) bringing at least one PCM solution into contact with at least one silica precursor, in particular an alkoxysilane, preferably chosen from (3-aminopropyl)triethoxysilane (APTES), trimethoxyphenylsilane (TMPS), tetraethyl orthosilicate (TEOS), tetramethyl orthosilicate (TMOS) and their mixtures, and an aqueous medium,
(ii) exposing the mixture obtained in stage (i) to conditions favorable to the polymerization of the silica precursor in order to encapsulate said PCM,
(iii) bringing the capsule obtained in stage (ii) into contact with at least one thermosetting polymer precursor in the presence of particles of at least one ancillary conducting material, and
(iv) exposing the mixture obtained in stage (iii) to conditions favorable to the polymerization of the thermosetting polymer precursor(s).

The alkoxysilanes which may advantageously be used as silica precursors are tetraethyl orthosilicate (TEOS), tetramethyl orthosilicate (TMOS) and their mixtures.

Mention may be made, as example of thermosetting polymer precursor, for example, of urea, melamine and formaldehyde, which, after polymerization, form a melamine-urea-formaldehyde copolymer.

The adjustment of the conditions favorable to the polymerization of the silica precursor of stage (ii), as well as those of the polymerization of precursor(s) of a thermosetting polymer, clearly comes within the competence of a person skilled in the art.

Thus, when said silica precursor is a silicon alkoxide, stage (ii) may, for example, be carried out in a basic medium, in particular by adding aqueous ammonia in order to catalyze the polymerization reaction.

According to a specific embodiment, the PCM-silica precursor mixture of stage (i) also comprises particles of a conducting material.

Advantageously, the corresponding capsules may be obtained by a microemulsion technique.

In this case, the PCM solution of stage (i) is an organic solution, in which the solvent is, for example, dichloromethane, styrene, toluene or their mixtures.

The particles of said conducting material of stage (iii) and, if appropriate, of stage (i) are advantageously boron nitride particles, in particular exfoliated hexagonal boron nitride nanosheets.

According to an advantageous alternative embodiment, these particles of conducting material(s) are employed in stage (iii) and, if appropriate, in stage (i) in conjunction with at least one polymer having a lower critical solubility temperature ranging from 30 to 100° C., preferably from 65 to 90° C., in particular of the order of 80° C. Advantageously, it is a water-soluble polymer having a lower critical solubility temperature of less than 80° C.

Mention may in particular be made, by way of representation and without limitation of these polymers having a critical solubility temperature, of copolymers of polyNipam-acrylates, of polyNipam, poly(vinyl methyl ether), polyoxazolines or hydroxypropylcellulose.

The polymer is advantageously poly(vinyl methyl ether) (Jeffamine).

According to this specific embodiment of the invention, the process according to the invention may comprise an ancillary stage of heating, simultaneously with or subsequent to stage (iv), at a temperature greater than the lower critical solubility temperature of said polymer.

This is because the inventors have found, contrary to all expectations that the heating of the reaction mixture considered in (iii) at a temperature greater than the lower critical solubility temperature of said polymer makes it possible, surprisingly, to optimize the confinement of the PCM to the core of the capsule simultaneously formed.

Applications

As specified above, the capsules according to the invention may be used in any heat transfer material in order to adjust and generally to increase the heat capacity thereof.

Furthermore, the capsules according to the invention may be used in a heat transfer material in order to adjust and in particular to increase the thermal conductivity thereof.

According to a specific embodiment, this heat transfer material is a thermal fluid, such as, for example, a polyaromatic oil or a molten salt.

The thermal fluid may in particular be an aromatic oil, in particular an aromatic oil dedicated to concentrated solar thermal power.

Mention may be made, as example of suitable oil for the transfer of heat in concentrated solar thermal power, of the polyaromatic oil sold under the name of Therminol 66 by Solutia Inc.

A person skilled in the art is in a position to determine the PCM(s) suitable for placing at the core of the capsules according to the invention from the viewpoint in the application under consideration.

Thus, in the case of a heat transfer material of aromatic oil type, particularly dedicated to concentrated solar thermal power, the capsules containing an aromatic PCM prove to be particularly advantageous.

The PCMs of aromatic type in particular, such as, for example, pyromellitic dianhydride, naphthalenetetracarboxylic dianhydride, perylenetetracarboxylic dianhydride, anthracene and their mixtures, and in particular anthracene, are then very particularly appropriate.

The amount of capsules in accordance with the invention to be used depends on the heat transfer material under consideration and on its use.

Advantageously, the capsules according to the invention may be present in a thermal fluid, in particular an aromatic oil dedicated to concentrated solar thermal power, in a fraction by volume ranging from 0.5 to 10%, in particular ranging from 1 to 8%, preferably from 2 to 5%.

The present invention also relates to a thermal fluid comprising capsules according to the invention.

According to yet another of its aspects, the present invention is also targeted at a thermally conducting inorganic particle encapsulating exfoliated hexagonal boron nitride nano sheets.

Such particles may advantageously exhibit a thermal conductivity of greater than 0.1 W/m/K, preferably of greater than 0.4 W/m/K, in particular of greater than 1 W/m/K.

Advantageously, such a particle is formed from silica.

According to an alternative embodiment, said exfoliated hexagonal boron nitride nanosheets are dispersed in said inorganic material forming said particle.

According to another alternative form, said particle exhibits a core-shell architecture, in which said exfoliated hexagonal boron nitride nanosheets are present at least at the periphery of said particle.

Such particles may, for example, be obtained by microemulsion, a reverse micelle technique or also a sol-gel technique.

These inorganic particles may in particular be used for the manufacture of a capsule in accordance with the invention.

According to yet another of its aspects, the present invention is targeted at a particle based on at least one organic or inorganic material encapsulating at least one aromatic PCM with a melting point ranging from 120 to 300° C., in particular from 150 to 270° C., and with a latent heat of fusion of greater than 100 J/g.

According to a first alternative embodiment, such a particle may be formed from at least one inorganic material, in particular silica.

According to another alternative embodiment, such a particle may be formed from at least one organic material, in particular from at least one thermosetting polymer chosen from polypropylene, a polyolefin, a polyamide, a polyurea, a urea-formaldehyde, melamine-urea-formaldehyde, an aminoplast, a phenoplast and their mixtures, preferably melamine-urea-formaldehyde.

Advantageously, the PCM is chosen from pyromellitic dianhydride, naphthalenetetracarboxylic dianhydride, perylenetetracarboxylic dianhydride, anthracene and their mixtures, and is in particular anthracene.

Such a particle may, for example, be composed of silica and may convey anthracene or be composed of melamine-urea-formaldehyde and may convey anthracene.

Advantageously, this type of particle in accordance with the invention exhibits a core-shell architecture, in which the PCM is concentrated in the core.

For example, it may be composed of a shell based on silica coating a core comprising anthracene or also of a shell based on melamine-urea-formaldehyde coating a core comprising anthracene.

This type of particle may be obtained by a microemulsion technique.

The particles encapsulating at least one PCM according to the invention may in particular be used for the manufacture of a capsule in accordance with the invention.

They may also be employed in a heat transfer material for adjusting and generally increasing the heat capacity thereof.

Unless otherwise mentioned, the expression “comprising a(n)” should be understood as “comprising at least one”.

Unless otherwise mentioned, the expression “between . . . and . . . ” should be understood as limits included.

Unless otherwise mentioned, the expression “ranging from . . . to . . . ” should be understood as limits included.

The examples and figures which follow are presented by way of illustration and without limitation of the field of the invention.

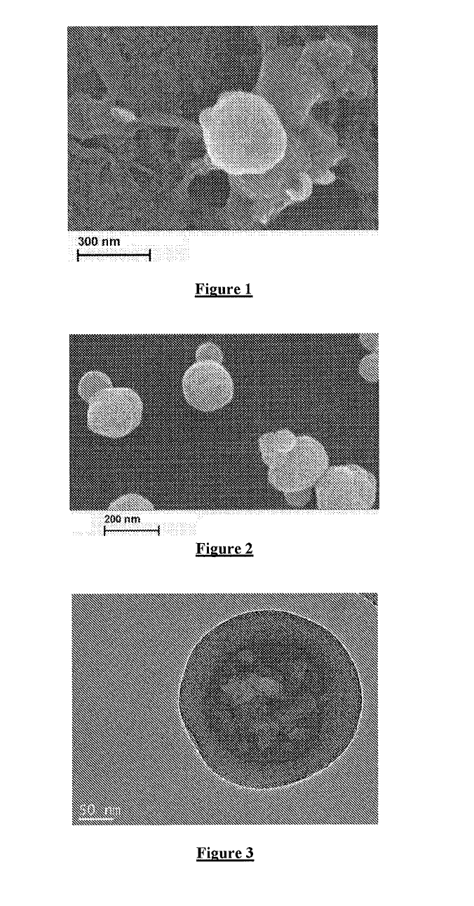

FIG. 1: Visualization by scanning electron microscopy (SEM) of a silica nanoparticle incorporating exfoliated hexagonal boron nitride nanosheets obtained by a reverse micelle technique.

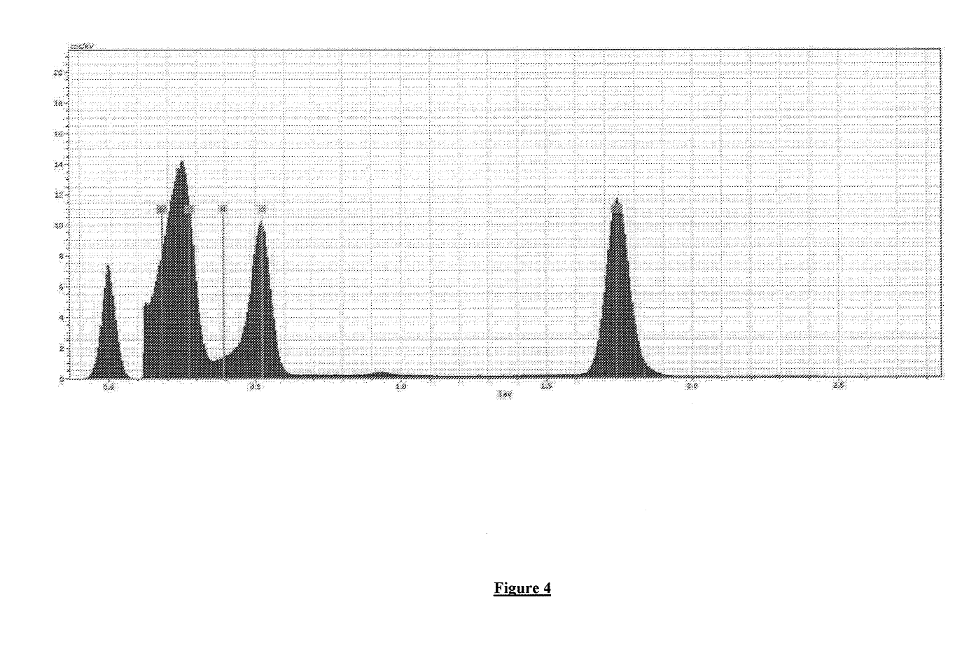

FIG. 2: Visualization by scanning electron microscopy (SEM) of silica nanoparticles incorporating exfoliated hexagonal boron nitride nanosheets obtained by a sol-gel technique.

FIG. 3: Visualization by transmission electron microscopy (TEM) of a silica nanoparticle incorporating exfoliated hexagonal boron nitride nanosheets obtained by a microemulsion technique.

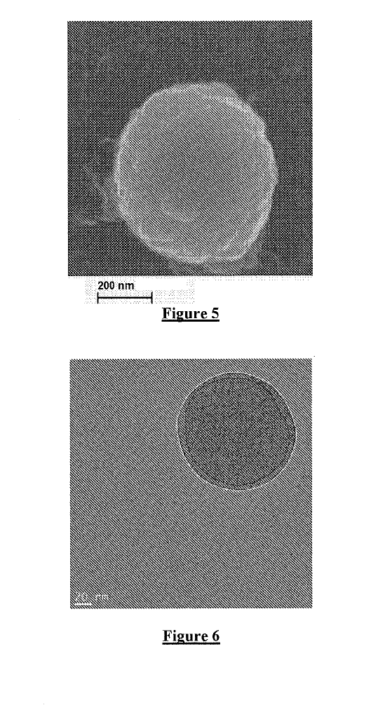

FIG. 4: Energy dispersive analysis (EDX) of the X-ray spectrum of silica nanoparticles incorporating exfoliated hexagonal boron nitride nanosheets obtained by a microemulsion technique.

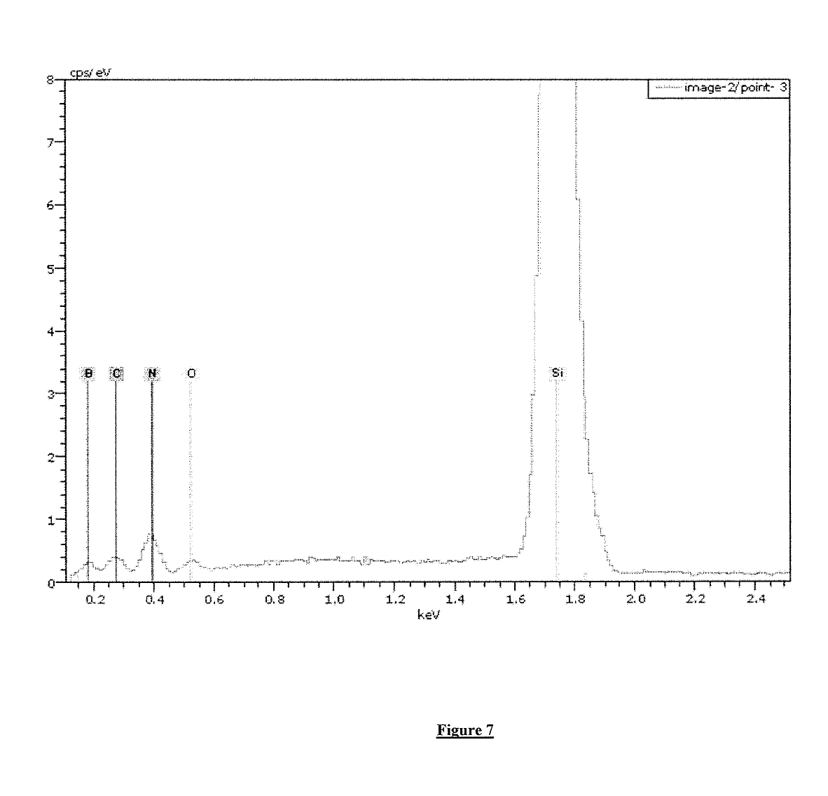

FIG. 5: Visualization by scanning electron microscopy (SEM) of a nanoparticle having a melamine-urea-formaldehyde shell encapsulating anthracene.

FIG. 6: Visualization by transmission electron microscopy (TEM) of a capsule having a core-shell structure, having a silica shell incorporating exfoliated hexagonal boron nitride nanosheets and containing anthracene at the core.

FIG. 7: Energy dispersive analysis (EDX) of the X-ray spectrum of capsules having a core-shell structure, having a melamine-urea-formaldehyde shell incorporating exfoliated hexagonal boron nitride nanosheets and containing anthracene at the core.

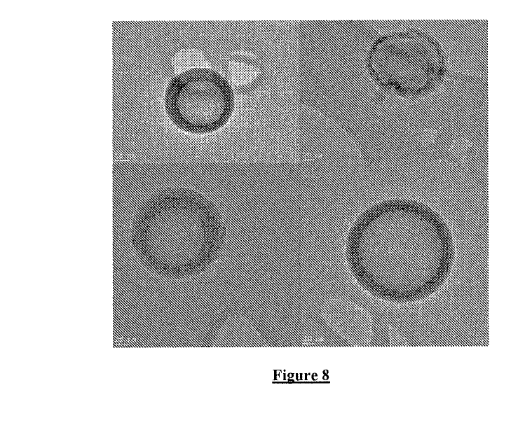

FIG. 8: Visualization by transmission electron microscopy (TEM) of a capsule having a core-shell structure, having a melamine-urea-formaldehyde shell incorporating exfoliated hexagonal boron nitride nanosheets and containing anthracene at the core.

### EQUIPMENT AND METHODS

In the examples which follow:
the ancillary conducting material under consideration is represented by exfoliated boron nitride nanosheets sold by Momentive.
the size of the particles or capsules is measured by transmission electron microscopy (TEM) or by scanning electron microscopy (SEM). The TEM is an FEI Technai Osiris (SDD Technology with silicon drift detector) and the SEM is a Leo 1550 VP Field Emission SEM equipped with an Oxford EDS probe.
the natures of the constituent atoms of the particles or capsules is characterized by an energy dispersive analysis (EDX) of the X-ray spectrum.
the presence of anthracene in the particles and capsules produced according to the invention is characterized:
   by emission and excitation photoluminescence spectrometry using the following device: Fluorolog 3 from Horiba Jobin Yvon. For these analyses, pellets of the different samples were prepared.
   by differential scanning calorimetry (DSC) on a Labsys™ Evo device from Setaram (the thermogram of the anthracene is characterized by an exothermic crystallization peak at approximately 200° C. and an endothermic melting peak at approximately 220° C.).
the resistance of the particles to high temperature is evaluated by DSC. In order to do this, 5 cycles were carried out according to the same procedure as that explained below for measuring the latent heats of fusion and of crystallization, the maximum temperature being, however, 350° C. for each cycle.
the latent heats of fusion and of crystallization were measured by DSC according to the following protocol:
   heating from 30° C. to 150° C. (10° C./min) under a nitrogen stream (30 ml/min) in order to desorb the molecules present at the surface of the sample
   cooling to 30° C. (10° C./min)
   waiting for 5 min at 30° C.
   subsequently 5 heating cycles up to 280° C., stationary phase of 10 min at this temperature and cooling down to 30° C. (gradients of 10° C./min in each case).

### Example 1

### Preparation of Silica Nanoparticles Incorporating Exfoliated Hexagonal Boron Nitride Nanosheets

a) By a Reverse Micelle Technique

The nanoparticles were prepared using the reverse microemulsion method [4].

The following chemicals were added in order to a 100 ml round-bottomed flask: the surfactant Triton X100 (4.2 ml), the cosurfactant n-hexanol (4.1 ml) and the organic solvent cyclohexane (19 ml). The solution is then stirred at ambient temperature for 15 minutes. The exfoliated boron nitride nanosheets in distilled water (300 μl, 0.01% by weight boron nitride solution) and also 28% aqueous ammonia (125 μl) are subsequently added to the solution. The emulsion formed is stirred for 15 minutes. The silicon alkoxides (3-aminopropyl)triethoxysilane (APTES) (1.5 μl) and tetraethoxysilane (TEOS) (123.75 μl) are added, simultaneously or nonsimultaneously, to this emulsion. The reaction mixture is then stirred at ambient temperature for 24 hours. Finally, the emulsion is destabilized by the addition of ethanol (45 ml). The nanoparticles are rinsed three times with ethanol and once with water. Each washing is followed by centrifuging at 8000 rpm for 10 min in order to settle out the nanoparticles. The silica nanoparticles obtained, and dispersed in water (5 ml) by a vortex mixer, are dialyzed in distilled water for three days.

The size of the particles obtained, which is in the vicinity of 300 nm, is reported in FIG. 1.

b) By a Sol-Gel Technique

The nanoparticles were synthesized by the sol-gel route according to the Stoller principle [5]. This method is based on the hydrolysis, followed by the condensation, of TEOS. These reactions take place in an aqueous solution of 28% aqueous ammonia and of alcohol (ethanol), where the aqueous ammonia acts catalyst for the two reactions of the TEOS (hydrolysis and condensation).

A solution of exfoliated boron nitride nanosheets in distilled water (5.40 ml of 0.01% by weight boron nitride solution) is introduced into a round-bottomed flask (temperature-regulated at 25° C.), followed by an aqueous ammonia solution (34 μl). After stirring for 10 minutes, 50 ml of ethanol are introduced. After stabilization of the reaction mixture (10 min), 5.02 ml of the TEOS solution are introduced. The solution obtained is then stirred at 25° C. for 3 hours. The nanoparticles are rinsed three times with ethanol and once with water. Each washing is followed by centrifuging at 8000 rpm for 10 minutes in order to settle out the nanoparticles. The silica nanoparticles obtained, and dispersed in water (5 ml) by a vortex mixer, are dialyzed in distilled water for three days.

The size of the particles obtained, which is in the vicinity of 200 nm, is reported in FIG. 2.

c) By a Microemulsion Technique

The microemulsion (oil-in-water) method was used for the synthesis of core-shell particles, the core of which is exfoliated boron nitride in O-(2-aminopropyl)-O′-(2-methoxyethyl) polypropylene glycol (Jeffamine 600) and the silica shell of which is produced by hydrolysis and condensation of the silica precursor trimethoxyphenylsilane (TMPS).

The procedure is as follows: 2.5 ml of solution of sodium dodecyl sulfate (SDS) in distilled water (0.5% by weight) and 2.5 ml of solution of polyvinyl alcohol (PVA) in distilled water (6.3% by weight) are added in the reaction beaker to 37.5 ml of distilled water with stirring. After stabilization of the mixture, the exfoliated boron nitride nanosheets/Jeffamine 600 solution (3.75 ml, comprising 0.03% by weight of boron nitride) is subsequently added. After stirring at ambient temperature for 10 minutes, the silicon alkoxide TMPS (547 μl) and the 28% aqueous ammonia solution (115 μl) are added to the mixture. After reacting for 3 hours, the particles are recovered and washed with ethanol, using successive centrifuging at 8000 rpm for 10 minutes. They are subsequently dialyzed in distilled water for 3 days.

The size of the particles obtained, which is in the vicinity of 250 nm, is reported in FIG. 3.

The particles obtained according to this protocol were characterized by energy dispersive analysis (EDX) of the X-ray spectrum, which is illustrated in FIG. 4. From the viewpoint of this figure, it is clearly apparent that the nanoparticles obtained comprise silicon, oxygen, nitrogen, carbon and boron.

On conclusion of each form a), b) or c), the resistance to heat of these particles was confirmed by DSC according to the protocol described in the section relating to the methods. For each of the forms, the particles obtained in this example withstand a temperature of 345-350° C. over many cycles.

### Example 2

### Preparation of Inorganic Nanoparticles Encapsulating a Phase Change Material (PCM)

The encapsulation of the anthracene is carried out by a microemulsion technique using the following conditions: 15 ml of SDS solution (0.5% by weight) and 15 ml of PVA solution (6.3% by weight) are added with stirring to the reaction beaker containing 75 ml of distilled water. At the same time, the anthracene is dissolved in 15 ml of dichloromethane. The latter solution is subsequently poured into the reaction beaker. After stirring at ambient temperature for 10 minutes, the silicon alkoxide TMPS and then the 28% aqueous ammonia solution (230 μl) are added to the mixture. After reacting for 3 hours, the particles are recovered and washed with ethanol (using successive centrifuging at 8000 rpm for 10 minutes). They are subsequently dialyzed in distilled water for 3 days.

The particles obtained were measured according to the protocol described in the section relating to the methods, and measure approximately 200 nm.

The presence of anthracene was demonstrated in the particles obtained by comparison of the emission and excitation photoluminescence spectra of anthracene with those of said particles obtained according to the protocol mentioned above.

### Example 3

### Preparation of Nanoparticles Having an Organic Shell Encapsulating a Phase Change Material (PCM)

These nanoparticles were obtained by a microemulsion technique. Urea (0.3 g) is dissolved in 15 ml of distilled water at ambient temperature with stirring with a motor (100 rpm) for 5 minutes. At the same time, anthracene (410 mg) is dissolved in dichloromethane (15 ml). Subsequently, a melamine-formaldehyde solution (35 ml of distilled water, 1.905 g of melamine and 1.296 g of formaldehyde), 15 ml of a 0.5% by weight solution of SDS in distilled water and 15 ml of a 6.3% by weight solution of PVA in distilled water are added to the reaction beaker with stirring at 300 rpm. The stirring rate is increased to 500 rpm before slowly adding the 15 ml of anthracene solution thereto. This stirring stage lasts 10 minutes, at ambient temperature, in order to produce a stable emulsion, and then the solution is heated to 86° C. The reaction is maintained under continuous stirring for 180 minutes with addition of 10 ml of distilled water every 60 minutes in order to replace the amount of water evaporated. After reacting for 3 hours, the particles are recovered and washed with ethanol (using successive centrifuging at 8000 rpm for 10 min). They are subsequently dialyzed in distilled water for 3 days.

The size of the particles obtained, which is in the vicinity of 600 nm, is reported in FIG. 5.

The presence of anthracene was demonstrated in the particles obtained by comparison of the emission and excitation photoluminescence spectra of anthracene with those of said particles obtained according to the protocol mentioned above.

It was confirmed by comparison of the thermograms obtained by DSC analysis of anthracene with those of said particles obtained according to the protocol mentioned above.

### Example 4

### Preparation of Capsules Having a Core-Shell Structure, Having an Inorganic Shell Incorporating Exfoliated Hexagonal Boron Nitride Nanosheets and Containing a PCM at the Core

The capsules are obtained by a microemulsion technique using the following conditions: 2.5 ml of SDS solution (0.5% by weight) and 2.5 ml of PVA solution (6.3% by weight) are added in the reaction beaker to 37.5 ml of distilled water with stirring. At the same time, the exfoliated boron nitride nanosheets/Jeffamine solution (3.75 ml, comprising 0.03% by weight of boron nitride) is mixed with 3.75 ml of dichloromethane and 410 mg of anthracene. After stirring at ambient temperature for 10 minutes, the silicon alkoxide TMPS (547 μl) and 115 μl of an aqueous ammonia solution are added to the mixture. After reacting for 3 hours, the particles are recovered and washed with ethanol (using successive centrifuging (8000 rpm) with a duration of 10 minutes). They are subsequently dialyzed in distilled water for 3 days.

The size of the particles obtained, which is in the vicinity of 150 nm, is reported in FIG. 6. This figure also makes it possible to report the core-shell structure of the capsule.

The particles obtained exhibit a core/shell molar ratio of 0.39/1.

### Example 5

### Preparation of Capsules Having a Core-Shell Structure, Having an Organic Shell Incorporating Exfoliated Hexagonal Boron Nitride Nanosheets and Containing a PCM at the Core

The capsules are obtained by a microemulsion technique using the following conditions: urea (0.3 g) is dissolved in 15 ml of distilled water at ambient temperature with stirring with a motor (100 rpm) for 5 minutes. At the same time, anthracene (410 mg) is dissolved in dichloromethane (15 ml) and is mixed with an exfoliated boron nitride nanosheet/Jeffamine solution (5 ml, comprising 0.03% by weight of boron nitride). Subsequently, the melamine-formaldehyde solution (35 ml of distilled water, 1.905 g of melamine and 1.296 g of formaldehyde), 15 ml of 0.5% by weight SDS solution and 15 ml of 6.3% by weight PVA solution are added to the reaction beaker with stirring at 300 rpm. The stirring rate is increased to 500 rpm before slowly adding the anthracene solution thereto. This stirring stage lasts 10 minutes at ambient temperature in order to produce the stable emulsion, before the temperature is raised up to 86° C. The reaction is maintained under continuous stirring for 180 minutes with addition of 10 ml of distilled water every 60 minutes in order to replace the amount of water evaporated. The nanoparticles are rinsed three times with ethanol and once with water. Each washing is followed by centrifuging at 8000 rpm for 10 minutes in order to settle out the nanoparticles. The nanoparticles obtained are dialyzed in distilled water for three days.

The capsules obtained thus exhibit a melamine-urea-formaldehyde shell with a 3/1/8.5 molar ratio. They exhibit a core/shell ratio by weight of 0.1/1.

The capsules obtained by this protocol were characterized by energy dispersive analysis (EDX) of the X-ray spectrum, which is illustrated in FIG. 7. From the viewpoint of this figure, it is clearly apparent that the capsules obtained comprise silicon, oxygen, nitrogen and carbon, the characterization of the nitrogen testifying to that of the boron.

The size of the particles obtained, which is approximately between 100 and 250 nm, is reported in FIG. 8.

The resistance to heat of these capsules was tested by subjecting them to 5 DSC cycles according to the protocol described in the section relating to the methods.

The thermograms obtained are identical during the 5 cycles, which shows a good stability with regard to heat of the capsules obtained.

### Example 6

### Preparation of Capsules Having a Core-Shell Structure, Having a Bilayer Shell Incorporating Exfoliated Hexagonal Boron Nitride Nanosheets and Containing a PCM at the Core

The encapsulation of the organic phase change material, anthracene, is carried out by a microemulsion technique using the following conditions: 15 ml of SDS solution (0.5% by weight) and 15 ml of PVA solution (6.3% by weight) are added in the reaction beaker to 75 ml of distilled water with stirring. At the same time, the anthracene is dissolved in 15 ml of dichloromethane and is mixed with an exfoliated boron nitride nanosheet/Jeffamine solution (3.75 ml, comprising 0.03% by weight of boron nitride). The latter solution is subsequently poured into the reaction beaker. After stirring at ambient temperature for 10 minutes, 1.15 g of silicon alkoxide TMPS and then the 28% aqueous ammonia solution (230 μl) are added to the mixture.

During this time, urea (0.3 g) is dissolved in 15 ml of distilled water at ambient temperature with stirring with a motor (100 rpm) for 5 minutes.

After reacting for 3 hours, the urea solution, a melamine-formaldehyde solution (35 ml of distilled water, 1.905 g of melamine and 1.296 g of formaldehyde) and also 5 ml of an exfoliated boron nitride nanosheet/Jeffamine solution comprising 0.03% by weight of boron nitride are added to the reaction beaker with stirring at 500 rpm. This stirring stage lasts 10 minutes, at ambient temperature, and then the solution is heated to 86° C. The reaction is maintained with continuous stirring for 180 minutes with addition of 10 ml of distilled water every 60 minutes in order to replace the amount of water evaporated.

After reacting for these 3 hours, the particles are recovered and washed with ethanol (using successive centrifuging at 8000 rpm for 10 min). They are subsequently dialyzed in distilled water for 3 days.

### Example 7

### Comparison of the Latent Heats of Fusion and of Crystallization Between the Particles Obtained in Example 3 and the Capsules Obtained in Example 5

The capsules obtained in example 5 are different from the particles obtained in example 3 solely in that they comprise exfoliated boron nitride nanosheets.

The latent heats of fusion and of crystallization are measured by DSC according to the protocol described in the section relating to the methods.

The measurements were taken at the end of one and of two cycles.

| Example concerned | Example 3 | Example 5 |
|---|---|---|
| Heat of fusion, l^{st} cycle | 29 | 52 |
| (μV.s.mg¹) | | |
| Heat of crystallization, l^{st} cycle | −19 | −50 |
| (μV.s.mg⁻¹) | | |
| Heat of crystallization, 2^{nd} cycle | −18 | −51 |
| (μV.s.mg⁻¹) | | |

This table underlines the fact that the presence of boron nitride in the particles very markedly increases the latent heats (by 80 to 180%), whether this is the latent heat of fusion or the latent heat of crystallization. From these results, it is very clearly apparent that the boron nitride forms thermal bridges between the PCM and the medium dedicated to containing the particles.

### BIBLIOGRAPHIC REFERENCES

[1] Influence of temperature on the deformation behaviors of melamine formaldehyde microcapsules containing phase change material, Jun-Feng Su, Xin-Yu Wang, Hua Dong, Materials Letters, 84 (2012), 158-161.
[2] Production of Melamine-Formaldehyde PCM Microcapsules with Ammonia Scavenger used for Residual Formaldehyde Reduction, Bo\check{s}tjan \check{S}umiga, Emil Knez, Margareta Vrta\check{c}nik, Vesna Ferk Savec, Marica Stare\check{s}ini\check{c} and Bojana Boh, Acta Chim. Slov., 2011, 58, 14-25.
[3] Review on microencapsulated phase change materials (MEPCMs): Fabrication, characterization and applications, C. Y. Zhao, G. H. Zhang, Renewable and Sustainable Energy Reviews, 15 (2011), 3813-3832.
[4] J. Langmuir, 2004, 20, 8336-8342.
[5] J. of Colloid and Interface Science, 1968, 26, 62-69.

1. A thermally conducting capsule having a core/shell structure, the core of which, surrounded by a leaktight and mono- or multilayer shell, is charged with at least one phase change material (PCM), wherein said capsule additionally comprises, at least in its shell, particles of at least one ancillary conducting material, said particles of said ancillary conducting material having a thermal conductivity of greater than 100 W/m/K, said ancillary conducting material comprising at least boron nitride particles.

2. The capsule as claimed in claim 1, wherein the thermal conductivity of said ancillary conducting material is at least 10 times greater than the thermal conductivity of said PCM.

3. The capsule as claimed in claim 1, wherein all or part of said particles of ancillary conducting material are in the form of sheets.

4. The capsule as claimed in claim 1, wherein said ancillary conducting material is composed of boron nitride particles.

5. The capsule as claimed in claim 1, wherein it additionally comprises, as ancillary conducting material, a material chosen from graphene, graphite and their mixtures.

6. The capsule as claimed in claim 1, wherein said boron nitride particles are particles of hexagonal boron nitride.

7. The capsule as claimed in claim 1, wherein the PCM exhibits a melting point ranging from 120 to 300° C.

8. The capsule as claimed in claim 1, wherein it comprises, as PCM, at least one aromatic compound.

9. The capsule as claimed in claim 8, wherein said aromatic compound is chosen from pyromellitic dianhydride, naphthalenetetracarboxylic dianhydride, perylenetetracarboxylic dianhydride, anthracene and their mixtures.

10. The capsule as claimed in claim 1, comprising a content of PCM ranging from 10 to 85% by weight, with respect to the total weight of said capsule.

11. The capsule as claimed in claim 1, wherein the shell is formed of a single or nonsingle layer comprising at least one organic material.

12. The capsule as claimed in claim 11, wherein said organic material is a thermosetting polymer chosen from polypropylene, a polyolefin, a polyamide, a polyurea, a urea-formaldehyde, melamine-urea-formaldehyde, an aminoplast, a phenoplast and their mixtures.

13. The capsule as claimed in claim 1, wherein in the shell is a monolayer shell.

14. The capsule as claimed in claim 1, wherein the shell is a bilayer shell, the layer in contact with the core of said capsule comprising at least silica and the external layer of said capsule comprising at least one thermosetting polymer.

15. The capsule as claimed in claim 1, comprising said particles of ancillary conducting material in a ratio by weight of particles of ancillary conducting material/monolayer or bilayer shell ranging from 0.5 to 10%.

16. The capsule as claimed in claim 1, wherein said shell exhibits a thickness of less than or equal to 50 nm.

17. The capsule as claimed in claim 1, wherein it exhibits a size ranging from 30 nm to 1 μm.

18. The capsule as claimed in claim 1, the core of which is charged with at least one aromatic PCM with a melting point ranging from 120 to 300° C., wherein said capsule additionally contains, at least in its shell, hexagonal boron nitride nanosheets.

19. A process for the preparation of a capsule having a bilayer shell as claimed in claim 14, comprising at least the stages consisting in:
(i) bringing at least one PCM solution into contact with at least one silica precursor and an aqueous medium,
(ii) exposing the mixture obtained in stage (i) to conditions favorable to the polymerization of the silica precursor in order to encapsulate said PCM,
(iii) bringing the capsule obtained in stage (ii) into contact with at least one thermosetting polymer precursor in the presence of at least of particles of boron nitride as ancillary conducting material, and
(iv) exposing the mixture obtained in stage (iii) to conditions favorable to the polymerization of the thermosetting polymer precursor(s).

20. The process as claimed in claim 19, wherein the PCM-silica precursor mixture of stage (i) additionally comprises particles of boron nitride as conducting material.

21. The process as claimed in claim 19, wherein said particles of boron nitride of stage (iii) and, if appropriate, of stage (i) are exfoliated hexagonal boron nitride nanosheets.

22. The process as claimed in claim 19, wherein said particles of a conducting material are employed with a polymer having a lower critical solubility temperature ranging from 30 to 100° C.

23. The process as claimed in claim 19, wherein it additionally comprises a stage of heating, simultaneously with or subsequent to stage (iv), at a temperature greater than the lower critical solubility temperature of said polymer.

24. A method for adjusting the heat capacity of a heat transfer material wherein the capsules as claimed in claim 1 are employed in said heat transfer material.

25. The method as claimed in claim 24, wherein the heat transfer material is a thermal fluid.

26. The method as claimed in claim 25, wherein said thermal fluid is an aromatic oil.

27. A thermal fluid comprising capsules as claimed in claim 1.

28-39. (canceled)
